(19) United States
(12) Patent Application Publication
(10) Pub. No.: US 2026/0185460 A1
(43) Pub. Date: Jul. 2, 2026

(54) MID-TURBINE FRAME DAMPING SYSTEM FOR A GAS TURBINE ENGINE

(71) Applicant: RTX Corporation, Farmington, CT (US)

(72) Inventor: Michael G. McCaffrey, Windsor, CT (US)

(21) Appl. No.: 19/008,241

(22) Filed: Jan. 2, 2025

(51) Int. Cl. F01D 25/04; F01D 25/24; F01D 25/28

(52) U.S. Cl. CPC F01D 25/04; F01D 25/24; F01D 25/28; F05D 2220/323; F05D 2240/58; F05D 2260/31

(57) ABSTRACT

A mid-turbine frame of a gas turbine engine includes a fairing and a damping system. The fairing includes an outer fairing wall, an inner fairing wall, and a plurality of struts. Each of the outer fairing wall and the inner fairing wall extends between and to an inner surface and an outer surface. The inner surface forms a core flow path through the fairing. One of the outer fairing wall or the inner fairing wall forms a damping wall of the fairing. The damping system includes at least one damping ring and a plurality of clamp assemblies. The at least one damping ring is disposed at the outer surface of the damping wall. The plurality of clamp assemblies is circumferentially arrayed on the damping wall about the axis. Each of the plurality of clamp assemblies clamps the at least one damping ring on the damping wall.

### BACKGROUND

### 1. Technical Field

This disclosure relates generally to gas turbine engines for aircraft propulsion systems and, more particularly, to a damping system for a gas turbine engine mid-turbine frame.

### 2. Background Information

Multi-spool gas turbine engines for aircraft propulsion systems may frequently include a mid-turbine frame configured to direct combustion gas flow from a high-pressure turbine to a low-pressure turbine. Various mid-turbine frame configurations are known in the art. While these known mid-turbine frame configurations may be suitable for their intended purposes, there is always room in the art for improvement.

### SUMMARY

According to an aspect of the present disclosure, a mid-turbine frame of a gas turbine engine includes an outer frame case, an inner frame case, a fairing, at least one piston ring seal, and a damping system. The outer frame case and the inner frame case extend circumferentially about an axis. The fairing is mounted to the outer frame case. The fairing is disposed radially between the outer frame case and the inner frame case. The fairing includes an outer fairing wall, an inner fairing wall, and a plurality of struts. The outer fairing wall and the inner fairing wall extend circumferentially about the axis. Each of the outer fairing wall and the inner fairing wall extends between and to an inner surface and an outer surface. The inner surface forms a core flow path through the fairing. The outer surface is disposed opposite the inner surface. The plurality of struts extend between and connect the outer fairing wall and the inner fairing wall. One of the outer fairing wall or the inner fairing wall forms a damping wall of the fairing. The at least one piston ring seal is disposed at the fairing. The damping system includes at least one damping ring and a plurality of clamp assemblies. Each of the at least one damping ring extends circumferentially about the axis. Each of the at least one damping ring includes a plurality of circumferential ring segments. The at least one damping ring is disposed at the outer surface of the damping wall. The plurality of clamp assemblies is circumferentially arrayed on the damping wall about the axis. Each of the plurality of clamp assemblies includes a clamp body mounted to the damping wall with the at least one damping ring disposed radially between the clamp body and the damping wall.

In any of the aspects or embodiments described above and herein, the fairing may form the core flow path radially between the outer fairing wall and the inner fairing wall.

In any of the aspects or embodiments described above and herein, the at least one damping ring may include a plurality of radially-stacked damping rings disposed radially between the clamp body and the damping wall.

In any of the aspects or embodiments described above and herein, each of the plurality of clamp assemblies may include a bolt mounting the clamp body to the damping wall.

In any of the aspects or embodiments described above and herein, the damping wall may form a bolt aperture for each of the plurality of clamp assemblies, the bolt aperture may extend through the damping wall from the outer surface to the inner surface, and the bolt may be disposed in the bolt aperture.

In any of the aspects or embodiments described above and herein, the bolt aperture may include a countersink aperture, the bolt may extend between and to an outer radial bolt end and an inner radial bolt end, the bolt may include a countersunk head at the inner radial bolt end, and the countersunk head may be disposed within the countersink aperture.

In any of the aspects or embodiments described above and herein, the inner radial bolt end may be flush with the inner surface.

In any of the aspects or embodiments described above and herein, each of the plurality of clamp assemblies may include a locking ring disposed on the bolt radially between the damping wall and the clamp body.

In any of the aspects or embodiments described above and herein, the clamp body may form an aperture, the bolt may extend through the aperture, and each of the plurality of clamp assemblies may include a nut threaded on the bolt radially outward of the clamp body.

In any of the aspects or embodiments described above and herein, the bolt may extend between and to an outer radial bolt end and an inner radial bolt end, and the bolt may form a tool mating interface at the outer radial bolt end.

In any of the aspects or embodiments described above and herein, the clamp body may include a plurality of arms radially coincident with the at least one damping ring, and the at least one damping ring may be disposed axially between the plurality of arms.

In any of the aspects or embodiments described above and herein, each of the clamp assemblies may be disposed circumferentially between a circumferentially-adjacent pair of the plurality of struts.

In any of the aspects or embodiments described above and herein, the fairing may be mounted to the outer frame case by a plurality of mounting pin assemblies, each of the mounting pin assemblies may include a mounting pin extending radially between and to the outer frame case and the outer fairing wall, and the fairing may be radially moveable on the mounting pin.

According to another aspect of the present disclosure, a gas turbine engine includes a high-pressure turbine, a low-pressure turbine, and mid-turbine frame. The high-pressure turbine and the low-pressure turbine form a core flow path through the gas turbine engine. The mid-turbine frame is disposed between the high-pressure turbine and the low-pressure turbine. The mid-turbine frame includes an outer frame case, an inner frame case, a fairing, at least one piston ring seal, and a damping system. The outer frame case and the inner frame case extend circumferentially about an axis. The fairing is mounted to the outer frame case. The fairing is disposed radially between the outer frame case and the inner frame case. The fairing includes an outer fairing wall, an inner fairing wall, and a plurality of struts. The outer fairing wall and the inner fairing wall extend circumferentially about the axis. The outer fairing wall and the inner fairing wall form a portion of the core flow path between the high-pressure turbine and the low-pressure turbine. Each of the outer fairing wall and the inner fairing wall extend between and to an outer surface and an inner surface. The inner surface forms the core flow path. The plurality of struts extend between and connect the outer fairing wall and the inner fairing wall. One of the outer fairing wall or the inner fairing wall forms a damping wall of the fairing. The at least one piston ring seal is disposed at the fairing. The at least one piston ring seal includes a first piston ring seal and a second piston ring seal. The first piston ring seal is disposed between the outer frame case and the outer fairing wall. The second piston ring seal is disposed between the inner frame case and the inner fairing wall. The damping system includes at least one damping ring and a plurality of clamp assemblies. Each of the at least one damping ring extends circumferentially about the axis. Each of the at least one damping ring includes a plurality of circumferential ring segments. The at least one damping ring is disposed at the outer surface. Each of the plurality of clamp assemblies is configured to clamp the at least one damping ring against the damping wall.

In any of the aspects or embodiments described above and herein, the high-pressure turbine may include a bladed turbine rotor, the bladed turbine rotor may include a trailing end rotor blade stage, the trailing end rotor blade stage may include a first quantity of rotor blades of the trailing end rotor blade stage, the damping system may include a second quantity of the plurality of clamp assemblies, and a ratio of the first quantity to the second quantity may be non-integral.

In any of the aspects or embodiments described above and herein, each of the clamp assemblies may be disposed circumferentially between a circumferentially-adjacent pair of the plurality of struts.

In any of the aspects or embodiments described above and herein, the at least one damping ring may include a plurality of radially-stacked damping rings disposed radially between the plurality of clamp assemblies and the damping wall.

According to another aspect of the present disclosure, a mid-turbine frame for a gas turbine engine includes an outer frame case, an inner frame case, a fairing, and a damping system. The outer frame case and the inner frame case extend circumferentially about an axis. The fairing is mounted between the outer frame case and the inner frame case. The fairing includes an outer fairing wall, an inner fairing wall, and a plurality of struts. The outer fairing wall and the inner fairing wall extend circumferentially about the axis. Each of the outer fairing wall and the inner fairing wall extend between and to an outer surface and an inner surface. The inner surface forms a core flow path through the fairing. The outer surface is disposed opposite the inner surface. The plurality of struts extend between and connect the outer fairing wall and the inner fairing wall. One of the outer fairing wall or the inner fairing wall forms a damping wall of the fairing. The damping system includes at least one damping ring and a plurality of clamp assemblies. Each of the at least one damping ring extends circumferentially about the axis. Each of the at least one damping ring includes a plurality of circumferential ring segments. The at least one damping ring is disposed at the outer radial surface. The plurality of clamp assemblies are circumferentially arrayed on the damping wall about the axis with each of the plurality of clamp assembly disposed circumferentially between a circumferentially-adjacent pair of the plurality of struts. Each of the plurality of clamp assemblies includes a clamp body mounted to the damping wall with the at least one damping ring disposed radially between the clamp body and the damping wall.

In any of the aspects or embodiments described above and herein, each of the plurality of clamp assemblies may include a bolt mounting the clamp body to the damping wall.

In any of the aspects or embodiments described above and herein, the outer fairing wall may form a bolt aperture for each of the plurality of clamp assemblies, the bolt aperture may extend through the damping wall from the outer radial surface to the inner radial surface, and the bolt may be disposed in the bolt aperture.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 illustrates a perspective view of an aircraft including a propulsion system, in accordance with one or more embodiments of the present disclosure.

FIG. 2 schematically illustrates a cutaway, side view of an aircraft propulsion system including a gas turbine engine, in accordance with one or more embodiments of the present disclosure.

FIG. 3 illustrates a cutaway, side view of a mid-turbine frame of the gas turbine engine, in accordance with one or more embodiments of the present disclosure.

FIG. 4 illustrates a cutaway view of a portion of a damping system for the mid-turbine frame, in accordance with one or more embodiments of the present disclosure.

FIG. 5 illustrates a perspective view of a portion of the damping system, in accordance with one or more embodiments of the present disclosure.

FIG. 6 illustrates a cutaway view of a portion of another damping system for the mid-turbine frame, in accordance with one or more embodiments of the present disclosure.

FIG. 7 illustrates a cutaway view of a portion of another damping system for the mid-turbine frame, in accordance with one or more embodiments of the present disclosure.

### DETAILED DESCRIPTION

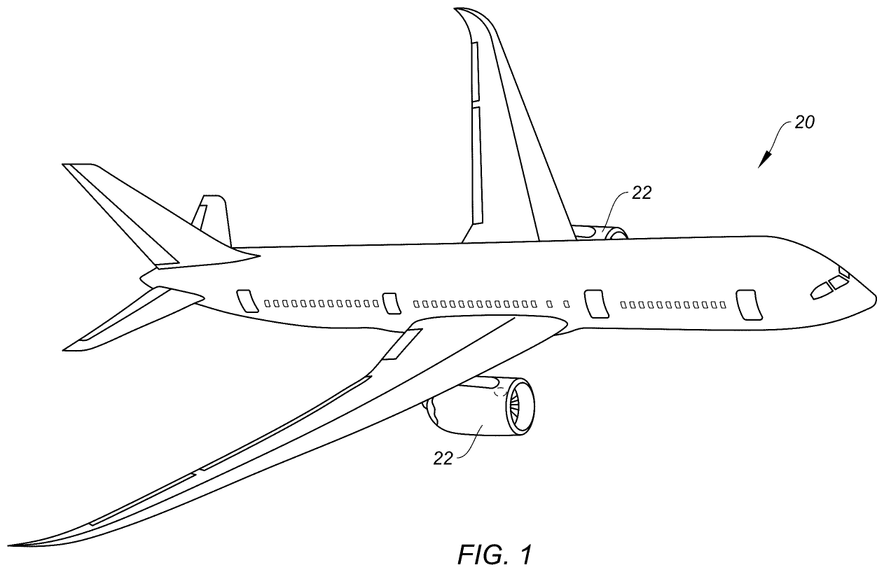

FIG. 1 illustrates an aircraft 20 including a propulsion system 22. The aircraft 20 may be a fixed-wing aircraft (e.g., an airplane) as shown, for example, in FIG. 1. The aircraft 20 may alternatively be a rotary-wing aircraft (e.g., a helicopter), a tilt-rotor aircraft, a tilt-wing aircraft, or another aerial vehicle. Moreover, the aircraft 20 may be a manned aerial vehicle or an unmanned aerial vehicle (UAV, e.g., a drone).

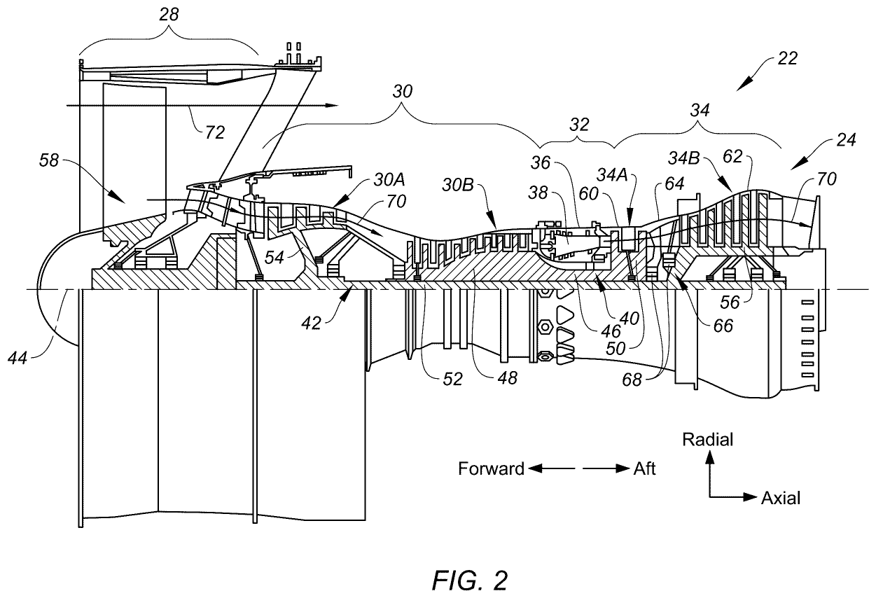

FIG. 2 schematically illustrates a cutaway, side view of the propulsion system 22. The propulsion system 22 of FIG. 2 includes a gas turbine engine 24. The gas turbine engine 24 of FIG. 2 is configured as a multi-spool turbofan gas turbine engine 24. However, while the following description and accompanying drawings may refer to the turbofan gas turbine engine 24 of FIG. 2 as an example, it should be understood that aspects of the present disclosure may be equally applicable to other types of gas turbine engines including, but not limited to, a turboshaft gas turbine engine, a turboprop gas turbine engine, a turbojet gas turbine engine, a propfan gas turbine engine, or an open rotor gas turbine engine.

The gas turbine engine 24 of FIG. 2 includes a fan section 28, a compressor section 30, a combustor section 32, a turbine section 34, and an engine static structure 36. The compressor section 30 includes a low-pressure compressor (LPC) 30A and a high-pressure compressor (HPC) 30B. The combustor section 32 includes a combustor 38 (e.g., an annular combustor). The turbine section 34 includes a high-pressure turbine (HPT) 34A and a low-pressure turbine (LPT) 34B.

Components of the fan section 28, the compressor section 30, and the turbine section 34 form a first rotational assembly 40 (e.g., a high-pressure spool) and a second rotational assembly 42 (e.g., a low-pressure spool) of the gas turbine engine 24. The first rotational assembly 40 and the second rotational assembly 42 are mounted for rotation about a rotational axis 44 (e.g., an axial centerline) of the gas turbine engine 24 relative to the engine static structure 36.

The first rotational assembly 40 includes a first shaft 46, a bladed first compressor rotor 48 for the high-pressure compressor 30B, and a bladed first turbine rotor 50 for the high-pressure turbine 34A. The first shaft 46 interconnects the bladed first compressor rotor 48 and the bladed first turbine rotor 50.

The second rotational assembly 42 includes a second shaft 52, a bladed second compressor rotor 54 for the low-pressure compressor 30A, a bladed second turbine rotor 56 for the low-pressure turbine 34B, and a bladed fan rotor 58 for the fan section 28. The second shaft 52 interconnects the bladed second compressor rotor 54 and the bladed second turbine rotor 56. The second shaft 52 may additionally interconnect the bladed fan rotor 58 with the bladed second compressor rotor 54 and the bladed second turbine rotor 56. Alternatively, the second shaft 52 may be coupled with the bladed fan rotor 58 by a gear assembly (e.g., a reduction gear box (RGB)). The first shaft 46 and the second shaft 52 are concentric and configured to rotate about the rotational axis 44. The present disclosure, however, is not limited to concentric configurations of the first shaft 46 and the second shaft 52.

The engine static structure 36 may include one or more engine cases, cowlings, bearing assemblies, inner fixed structures, and/or other non-rotating structures configured to house and/or support (e.g., rotationally support) components of the gas turbine engine sections 28, 30, 32, 34. The engine static structure 36 of FIG. 2 includes, in particular, a high-pressure turbine case 60, a low-pressure turbine case 62, and a mid-turbine frame 64. The high-pressure turbine case 60 circumscribes the bladed first turbine rotor 50. The low-pressure turbine case 62 circumscribes the bladed second turbine rotor 56. The mid-turbine frame 64 extends between and connects the high-pressure turbine case 60 and the low-pressure turbine case 62. The mid-turbine frame 64 supports a bearing assembly 66 of the engine static structure 36. The bearing assembly 66 may include one or more bearings 68 configured to rotationally support the first rotational assembly 40 (e.g., the first shaft 46) and/or the second rotational assembly 42 (e.g., the second shaft 52).

In operation of the gas turbine engine 24, ambient air is directed through the fan section 28 and into a core flow path 70 (e.g., an annular flow path) and a bypass flow path 72 (e.g., an annular flow path) by rotation of the bladed fan rotor 58. Air flow along the core flow path 70 is compressed by the low-pressure compressor 30A and the high-pressure compressor 30B, mixed and burned with fuel in the combustor 38, and then directed through the high-pressure turbine 34A and the low-pressure turbine 34B. The high-pressure turbine case 60, the mid-turbine frame 64, and the low-pressure turbine case 62 sequentially form portions of the core flow path 70 through the turbine section 34. The bladed first turbine rotor 50 and the bladed second turbine rotor 56 rotationally drive the first rotational assembly 40 and the second rotational assembly 42, respectively, in response to the combustion gas flow through the high-pressure turbine 34A and the low-pressure turbine 34B.

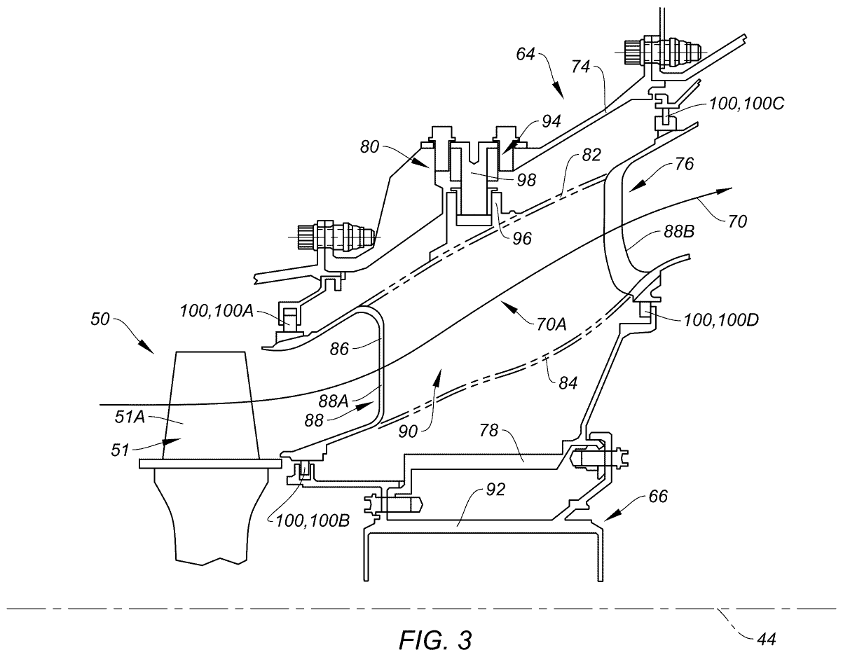

FIG. 3 illustrates a cutaway, side view of the mid-turbine frame 64. The mid-turbine frame 64 of FIG. 3 includes an outer frame case 74, a fairing 76, an inner frame case 78, and a plurality of mounting pin assemblies 80.

The outer frame case 74 extends between and connects the high-pressure turbine case 60 and the low-pressure turbine case 62. For example, the outer frame case 74 of FIG. 3 is mounted onto the high-pressure turbine case 60 and the low-pressure turbine case 62. The outer frame case 74 extends circumferentially about (e.g., completely around) the rotational axis 44.

The fairing 76 is disposed radially between the outer frame case 74 and the inner frame case 78. The fairing 76 is mounted (e.g., moveably mounted) onto the outer frame case 74 by the mounting pin assemblies 80. The fairing 76 includes an outer fairing wall 82, an inner fairing wall 84, and a plurality of fairing struts 86. The outer fairing wall 82 and the inner fairing wall 84 extend circumferentially about (e.g., completely around) the rotational axis 44. The outer fairing wall 82 and the inner fairing wall 84 form an inter-turbine portion 70A of the core flow path 70 through the mid-turbine frame 64 from the high-pressure turbine 34A to the low-pressure turbine 34B. The outer fairing wall 82 and the inner fairing wall 84 form the inter-turbine portion 70A of the core flow path 70 radially therebetween. As shown in FIG. 3, the outer fairing wall 82 and the inner fairing wall 84 may each have a conical configuration, for example, extending radially outward in a forward to aft axial direction. The fairing struts 86 extend radially between and connect the outer fairing wall 82 and the inner fairing wall 84. The fairing struts 86 are circumferentially arrayed (e.g., distributed) about the rotational axis 44. The fairing struts 86 may form a respective plurality of turning vanes 88 configured to turn combustion gas flow along the core flow path 70 to correct an incident angle of the combustion gas flow for the downstream low-pressure turbine 34B (e.g., a first blade stage of the bladed second turbine rotor 56; see FIG. 2). Each of the vanes 88 may extend between and to a leading edge 88A and a trailing edge 88B. Some or all of the fairing struts 86 may be hollow such that each of the hollow fairing struts 86 forms a radial passage 90 extending through the fairing 76 (e.g., the outer fairing wall 82, the inner fairing wall 84, and a respective one of the fairing struts 86). The radial passage 90 may accommodate oil supply lines (e.g., to the bearing assembly 66), cooling air flow, and the like. Components of the fairing 76, such as the outer fairing wall 82, the inner fairing wall 84, and the fairing struts 86 may form a unitary structure of the fairing 76 (e.g., a monolithic fairing structure). The term “unitary structure” as used herein means a single component, wherein all elements of the fairing 76 (e.g., the outer fairing wall 82, the inner fairing wall 84, and the fairing struts 86) are an inseparable body (e.g., formed of a single material, or a weldment of independent elements, etc.).

The inner frame case 78 is mounted to the outer frame case 74. For example, the inner frame case 78 may be mounted to the outer frame case 74 by a plurality of support rods (not shown) extending between and connecting the inner frame case 78 to the outer frame case 74. Each of the support rods may extend through the radial passage 90 of a respective one of the fairing struts 86. The present disclosure, however, is not limited to any particular mounting configuration of the inner frame case 78 relative to the outer frame case. The inner frame case 78 extends circumferentially about (e.g., completely around) the rotational axis 44. The inner frame case 78 structurally supports the bearing assembly 66. For example, the inner frame case 78 may support a bearing compartment housing 92 of the bearing assembly 66 mounted to the inner frame case 78.

The mounting pin assemblies 80 moveable mount the fairing 76 to the outer frame case 74. The mounting pin assemblies 80 are circumferentially arrayed (e.g., distributed) about the rotational axis 44. Each of the mounting pin assemblies 80 includes an outer pin boss 94, an inner pin boss 96, and a mounting pin 98. The outer pin boss 94 is disposed at (e.g., on, adjacent, or proximate) the outer frame case 74. The inner pin boss 96 is disposed at (e.g., on, adjacent, or proximate) the outer fairing wall 82. The mounting pin 98 extends through (e.g., radially through) the outer pin boss 94 and the inner pin boss 96. The mounting pin 98 may be fixedly mounted at (e.g., on, adjacent, or proximate) the outer pin boss 94. The inner pin boss 96 may be radially moveable on the mounting pin 98 to facilitate radial movement of the fairing 76 relative to the outer frame case 74 and the inner frame case 78, and thereby accommodate thermal expansion and contraction of the fairing 76 during gas turbine engine 24 operations. Thermal expansion and contraction of the fairing 76 may be particularly significant for unitary configurations of the fairing 76.

The mid-turbine frame 64 includes a plurality of seals 100 configured to facilitate fluid sealing between the fairing 76 (and the inter-turbine portion 70A of the core flow path 70) and the frame cases 74, 78. The seals 100 include an outer leading end seal 100A, an inner leading end seal 100B, an outer trailing end seal 100C, and an inner trailing end seal 100D. These seals 100A-D may be configured as piston rings to facilitate fluid sealing while accommodating radial movement of the fairing 76 relative to the frame cases 74, 78. The outer leading end seal 100A and the outer trailing end seal 100C may be disposed at (e.g., on, adjacent, or proximate) the outer fairing wall 82, for example, between the outer fairing wall 82 and the outer frame case 74. The inner leading end seal 100B and the inner trailing end seal 100D may be disposed at (e.g., on, adjacent, or proximate) the inner fairing wall 84, for example, between the inner fairing wall 84 and the inner frame case 78.

During operation of the gas turbine engine 24, the combustion gas wake off of the trailing edge of the high-pressure turbine 34A rotor (e.g., the bladed first turbine rotor 50) may impart vibrational waves in the mid-turbine frame 64, which vibrational waves may travel circumferentially through the mid-turbine frame 64 with the bladed first turbine rotor 50 as it rotates. In particular, each of a plurality of rotor blades 51A of a trailing-end rotor blade stage 51 of the bladed first turbine rotor 50 impart a circumferentially-traveling vibrational wave in the mid-turbine frame 64. These vibrational waves may impart some limited mechanical strain on the mid-turbine frame 64 structure. More importantly, these vibrational waves may cause repeated and rapid radial movement of the piston ring seals 100A-D, thereby accelerating degradation of the seals 100.

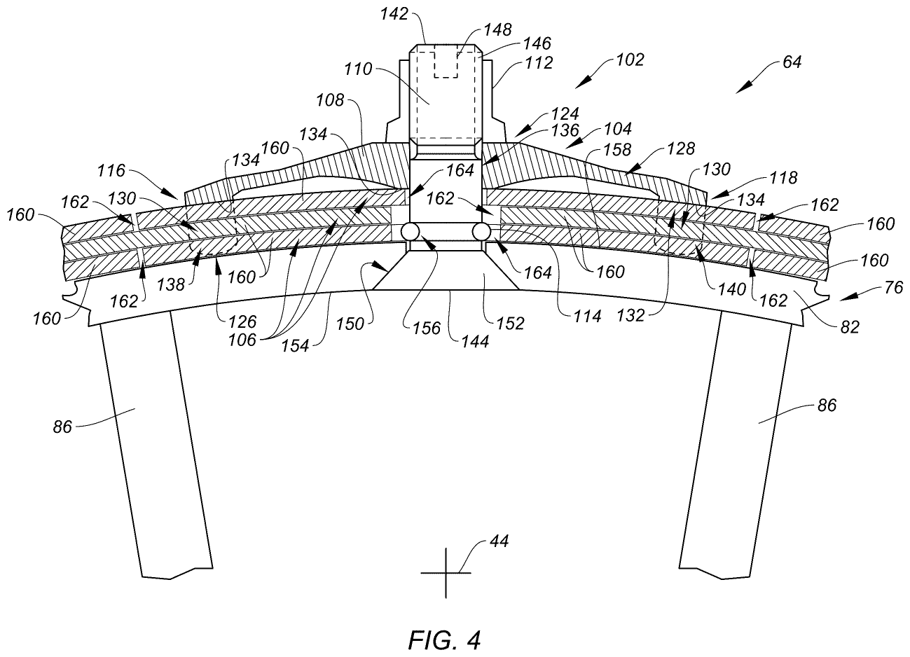

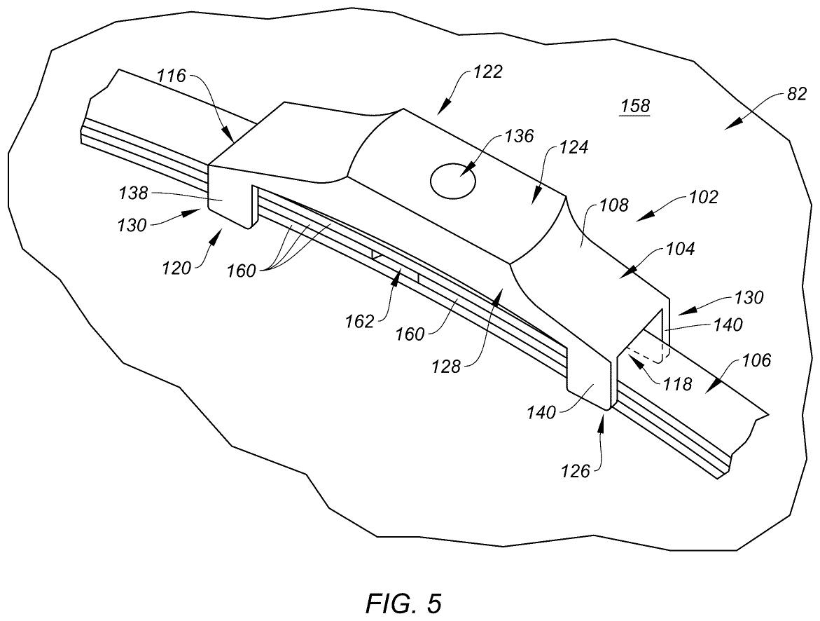

Referring to FIGS. 4 and 5, the mid-turbine frame 64 includes a damping system 102. The damping system 102 includes a plurality of clamp assemblies 104 and one or more damping rings 106. The clamp assemblies 104 are circumferentially arrayed (e.g., distributed) on the fairing 76 (e.g., the outer fairing wall 82) about the rotational axis 44. For example, each of the clamp assemblies 104 may be disposed circumferentially between a respective circumferentially-adjacent pair of the fairing struts 86. The damping system 102 may be disposed on the fairing 76 axially between the leading edge 88A and the trailing edge 88B of each of the vanes 88 (see FIG. 3). For example, the damping system 102 may be disposed axially forward of or axially aftward of the inner pin boss 96 and the mounting pin 98. The present disclosure, however, is not limited to any particular axial position of the damping system 102 on the fairing 76. In some embodiments, the mid-turbine frame 64 may include a plurality of damping systems 102 disposed at different axial positions on the fairing 76. FIG. 4 illustrates a cutaway view of one of the clamp assemblies 104 at a circumferential position on the fairing 76. FIG. 5 illustrates a perspective view of one of the clamp assemblies 104 on the fairing 76.

The clamp assemblies 104 each include a clamp body 108, a bolt 110, and a nut 112. The bolt 110 and the nut 112 are omitted in FIG. 5 for clarity of the clamp body 108. The clamp assemblies 104 may additionally each include a locking ring 114.

The clamp body 108 extends between and to a first circumferential end 116 of the clamp body 108 and a second circumferential end 118 of the clamp body 108. The clamp body 108 extends between and to a first axial end 120 of the clamp body 108 and a second axial end 122 of the clamp body 108. The clamp body 108 extends between and to an outer end 124 (relative to the core flow path 70) of the clamp body 108 and an inner end 126 (relative to the core flow path 70) of the clamp body 108. The clamp body 108 includes a clamp portion 128 and a plurality of retaining arm portions 130. The clamp portion 128 forms a clamping side 132 of the clamp body 108. The clamping side 132 forms one or more clamping surfaces 134 of the clamp body 108. The clamp portion 128 extends (e.g., radially extends) between and to the outer end 124 and the clamping side 132. The clamp portion 128 forms a center aperture 136 extending radially through the clamp portion 128 from the outer end 124 to the clamping side 132. The retaining arm portions 130 include first retaining arms 138 and second retaining arms 140. The first retaining arms 138 and the second retaining arms 140 are disposed radially coincident with the damping rings 106. The first retaining arms 138 are axially opposing retaining arms disposed at the first axial end 120 and the second axial end 122. The first retaining arms 138 are disposed at the first circumferential end 116. The second retaining arms 140 are axially opposing retaining arms disposed at the first axial end 120 and the second axial end 122. The second retaining arms 140 are disposed at the second circumferential end 118. Each of the retaining arms 138, 140 extends (e.g., radially extends) between and to the clamping side 132 and the inner end 126.

The bolt 110 extends between and to an outer end 142 (relative to the core flow path 70) of the bolt 110 and an inner end 144 (relative to the core flow path 70) of the bolt 110. The outer end 142 is disposed radially outward of the outer fairing wall 82. The bolt 110 includes a threaded interface 146 along a portion of its length at the outer end 142. The bolt 110 may further include a tool mating interface 148 on the outer end 142. The tool mating interface 148 may be any tool interface (e.g., male or female tool interface) such as, but not limited to, a hex drive interface (e.g., a hex socket), a square drive interface (e.g., a square socket), or any other suitable rotational-driving interface configured for engagement with a tool (e.g., a hand tool such as a wrench). The inner end 144 is disposed at (e.g., on, adjacent, or proximate) the outer fairing wall 82. In particular, the bolt 110 extends (e.g., radially extends) through a bolt aperture 150 formed through (e.g., radially through) the outer fairing wall 82. The bolt 110 may extend through the bolt aperture 150 such that the inner end 144 further forms the inter-turbine portion 70A of the core flow path 70. In some embodiments, the bolt 110 may be configured as a countersunk bolt having an enlarged conical head 152 on the inner end 144. The inner end 144 at the enlarged conical head 152 (e.g., a countersunk head) may be flush with or substantially flush with an inner surface 154 (relative to the core flow path 70) of the outer fairing wall 82. The bolt aperture 150 may similarly be configured as a countersink hole. The bolt 110 extends (e.g., radially extends) through the center aperture 136 of the clamp body 108. The bolt 110 extends (e.g., radially extends) through the damping rings 106, as will be discussed below in further detail. The nut 112 is engageable with the threaded interface 146, for example, radially outward of the clamp body 108.

In some embodiments, each of the clamp assemblies 104 may include the locking ring 114. The locking ring 114 may be disposed in a corresponding locking ring groove 156 formed by the bolt 110, for example, at (e.g., on, adjacent, or proximate) and radially outward of the enlarged conical head 152. The locking ring 114 may have a diameter which is greater than a diameter of the bolt aperture 150 at (e.g., on, adjacent, or proximate) an outer surface 158 relative to the core flow path 70) of the outer fairing wall 82. The locking ring 114 may facilitate retention of the bolt 110 on the outer fairing wall 82, for example, to prevent the bolt 110 from falling into the core flow path 70. The locking ring 114 is disposed between (e.g., radially between) the clamp body 108 and the outer fairing wall 82. For example, the locking ring 114 may be disposed radially coincident with the damping rings 106 as show in FIG. 4.

Each of the damping rings 106 extends circumferentially about the rotational axis 44. Each of the damping rings 106 includes a plurality of circumferential ring segments 160 (e.g., metal ring segments) arranged together to form a respective one of the damping rings 106 extending circumferentially about the rotational axis 44. Each of the ring segments 160 may be circumferentially spaced from each other one of the ring segments 160 of a respective one of the damping rings 106 by a circumferential gap 162. The circumferential gap 162 accommodates thermal expansion and contraction of the ring segments 160. Each of the ring segments 160 may be held in place against the outer fairing wall 82 or another one of the damping rings 106 by one or more of the clamp assemblies 104. The damping system 102 may include a single damping ring 106 mounted against the outer fairing wall 82 (e.g., the outer surface 158) by the clamp assemblies 104 (e.g., each of the clamp assemblies 104). Alternatively, the damping system 102 may include a plurality of the damping rings 106 radially stacked together. For example, the damping system 102 of FIGS. 4 and 5 includes three radially-stacked damping rings 106. The ring segments 160 of each of the damping rings 106 may be circumferentially staggered relative to the ring segments 160 of each radially adjacent one of the damping rings 106. The present disclosure, however, is not limited to any particular quantity of the damping rings 106 and said quantity may be selected to facilitate suitable damping for the mid-turbine frame 64. The damping rings 106 are disposed (e.g. clamped) between the clamp body 108 (e.g., the clamping surface 134) of each of the clamp assemblies 104. The damping rings 106 are further disposed between (e.g., axially between) the first retaining arms 138 and the second retaining arms 140. As previously discussed the bolt 110 extends (e.g., radially extends) through the damping rings 106. The bolt 110 may extend through the circumferential gap 162 between circumferentially-adjacent ring segments 160. Additionally or alternatively, the damping rings 106 (e.g., the ring segments 160) may form bolt apertures 164 through which the bolt 110 extends.

For each of the clamp assemblies 104, the nut 112 is threadably engaged with the threaded interface 146 to clamp the damping rings 106 against the outer fairing wall 82. For example, the bolt 110 may be held rotationally fixed with a tool (e.g., a hand tool) engaged with the tool mating interface 148 while tightly threading the nut 112 onto the threaded interface 146. The damping rings 106, clamped against the outer fairing wall 82, facilitate friction damping of the fairing 76, thereby reducing vibration at the fairing 76 and, more particularly, at the seals 100 (e.g., piston seals). A quantity of the clamp assemblies 104 of the damping system 102 may be selected to establish a non-integral ratio between a quantity of the rotor blades 51A of the trailing-end rotor blade stage 51 of the bladed first turbine rotor 50 (see FIG. 3; e.g., corresponding to a quantity of vibrational waves through the mid-turbine frame 64 per bladed first turbine rotor 50 rotation) and the quantity of the clamp assemblies 104 such that the damping rings 106 do not resonate in response to the vibrational waves.

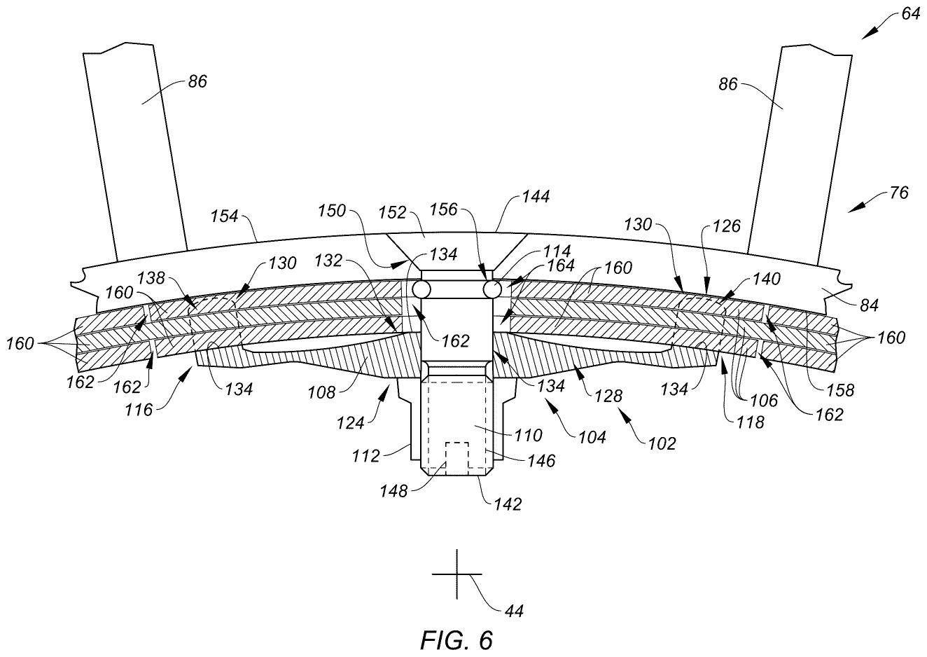

Referring to FIG. 6, in some embodiments, the damping system 102 may be installed on the inner fairing wall 84. In some other embodiments, the instances of the damping system 102 may be installed on both the outer fairing wall 82 (see FIG. 4) and the inner fairing wall 84. The outer fairing wall 82 and/or the inner fairing wall 84 having the damping system 102 installed thereon may be referred to herein as a “damping wall” of the fairing 76. The clamp assemblies 104 may be circumferentially arrayed (e.g., distributed) on the inner fairing wall 84 about the rotational axis 44. The outer end 142 is disposed radially inward of the inner fairing wall 84. The inner end 144 is disposed at (e.g., on, adjacent, or proximate) the inner fairing wall 84. In particular, the bolt 110 extends (e.g., radially extends) through the bolt aperture 150 formed through (e.g., radially through) the inner fairing wall 84. The bolt 110 may extend through the bolt aperture 150 such that the inner end 144 further forms the inter-turbine portion 70A of the core flow path 70. The inner end 144 at the enlarged conical head 152 (e.g., a countersunk head) may be flush with or substantially flush with an inner surface 154 of the inner fairing wall 84. The locking ring 114 may facilitate retention of the bolt 110 on the inner fairing wall 84, similar to that described above for the outer fairing wall 82. Each of the ring segments 160 may be held in place against the inner fairing wall 84 or another one of the damping rings 106 by one or more of the clamp assemblies 104. The damping system 102 may include a single damping ring 106 mounted against the inner fairing wall 84 (e.g., the outer surface 158) by the clamp assemblies 104 (e.g., each of the clamp assemblies 104). Alternatively, the damping system 102 may include a plurality of the damping rings 106 radially stacked together. For example, the damping system 102 of FIG. 6 includes three radially-stacked damping rings 106. For each of the clamp assemblies 104, the nut 112 is threadably engaged with the threaded interface 146 to clamp the damping rings 106 against the inner fairing wall 84. The damping rings 106, clamped against the inner fairing wall 84, facilitate friction damping of the fairing 76, similar to that described above for the outer fairing wall 82.

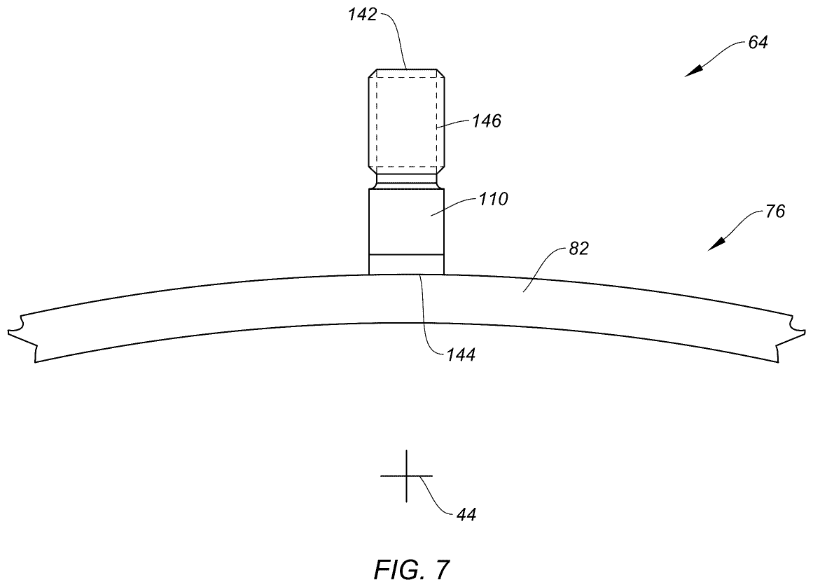

Referring to FIG. 7, in some embodiments, the bolt 110 may be fixedly mounted to the outer fairing wall 82 (or the inner fairing wall 84) and the bolt aperture 150 of the outer fairing wall 82 (or the inner fairing wall 84) may be omitted. For example, the outer fairing wall 82 and the bolt 110 may form a unitary structure. The term “unitary structure” as used herein means a single component, wherein the outer fairing wall 82 (or the inner fairing wall 84) and the bolt 110 are an inseparable body (e.g., formed of a single material such as an integral casting), a brazed joint, or a weldment of independent elements.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected, or the like may include permanent, removable, temporary, partial, full and/or any other possible attachment option.

The terms “substantially,” “about,” “approximately,” and other similar terms of approximation used throughout this patent application are intended to encompass variations or ranges that are reasonable and customary in the relevant field. These terms should be construed as allowing for variations that do not alter the basic essence or functionality of the invention. Such variations may include, but are not limited to, variations due to manufacturing tolerances, materials used, or inherent characteristics of the elements described in the claims, and should be understood as falling within the scope of the claims unless explicitly stated otherwise.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

1. A mid-turbine frame of a gas turbine engine, the mid-turbine frame comprising:
an outer frame case and an inner frame case extending circumferentially about an axis;
a fairing mounted to the outer frame case, the fairing disposed radially between the outer frame case and the inner frame case, the fairing including an outer fairing wall, an inner fairing wall, and a plurality of struts, the outer fairing wall and the inner fairing wall extending circumferentially about the axis, each of the outer fairing wall and the inner fairing wall extending between and to an inner surface and an outer surface, the inner surface forming a core flow path through the fairing, the outer surface disposed opposite the inner surface, the plurality of struts extending between and connecting the outer fairing wall and the inner fairing wall, one of the outer fairing wall or the inner fairing wall forming a damping wall of the fairing;
at least one piston ring seal disposed at the fairing; and
a damping system including at least one damping ring and a plurality of clamp assemblies, each of the at least one damping ring extending circumferentially about the axis, each of the at least one damping ring including a plurality of circumferential ring segments, the at least one damping ring disposed at the outer surface of the damping wall, the plurality of clamp assemblies circumferentially arrayed on the damping wall about the axis, each of the plurality of clamp assemblies including a clamp body mounted to the damping wall with the at least one damping ring disposed radially between the clamp body and the damping wall.

2. The mid-turbine frame of claim 1, wherein the fairing forms the core flow path radially between the outer fairing wall and the inner fairing wall.

3. The mid-turbine frame of claim 1, wherein the at least one damping ring includes a plurality of radially-stacked damping rings disposed radially between the clamp body and the damping wall.

4. The mid-turbine frame of claim 1, wherein each of the plurality of clamp assemblies includes a bolt mounting the clamp body to the damping wall.

5. The mid-turbine frame of claim 4, wherein the damping wall forms a bolt aperture for each of the plurality of clamp assemblies, the bolt aperture extends through the damping wall from the outer surface to the inner surface, and the bolt is disposed in the bolt aperture.

6. The mid-turbine frame of claim 5, wherein the bolt aperture includes a countersink aperture, the bolt extends between and to an outer radial bolt end and an inner radial bolt end, the bolt includes a countersunk head at the inner radial bolt end, and the countersunk head is disposed within the countersink aperture.

7. The mid-turbine frame of claim 6, wherein the inner radial bolt end is flush with the inner surface.

8. The mid-turbine frame of claim 5, wherein each of the plurality of clamp assemblies includes a locking ring disposed on the bolt radially between the damping wall and the clamp body.

9. The mid-turbine frame of claim 4, wherein the clamp body forms an aperture, the bolt extends through the aperture, and each of the plurality of clamp assemblies includes a nut threaded on the bolt radially outward of the clamp body.

10. The mid-turbine frame of claim 9, wherein the bolt extends between and to an outer radial bolt end and an inner radial bolt end, and the bolt forms a tool mating interface at the outer radial bolt end.

11. The mid-turbine frame of claim 1, wherein the clamp body includes a plurality of arms radially coincident with the at least one damping ring, and the at least one damping ring is disposed axially between the plurality of arms.

12. The mid-turbine frame of claim 1, wherein each of the clamp assemblies is disposed circumferentially between a circumferentially-adjacent pair of the plurality of struts.

13. The mid-turbine frame of claim 1, wherein the fairing is mounted to the outer frame case by a plurality of mounting pin assemblies, each of the mounting pin assemblies includes a mounting pin extending radially between and to the outer frame case and the outer fairing wall, and the fairing is radially moveable on the mounting pin.

14. A gas turbine engine of an aircraft propulsion system, the gas turbine engine comprising:
a high-pressure turbine and a low-pressure turbine forming a core flow path through the gas turbine engine; and
a mid-turbine frame disposed between the high-pressure turbine and the low-pressure turbine, the mid-turbine frame including:
an outer frame case and an inner frame case extending circumferentially about an axis;
a fairing mounted to the outer frame case, the fairing disposed radially between the outer frame case and the inner frame case, the fairing including an outer fairing wall, an inner fairing wall, and a plurality of struts, the outer fairing wall and the inner fairing wall extending circumferentially about the axis, the outer fairing wall and the inner fairing wall forming a portion of the core flow path between the high-pressure turbine and the low-pressure turbine, each of the outer fairing wall and the inner fairing wall extending between and to an outer surface and an inner surface, the inner surface forming the core flow path, the plurality of struts extending between and connecting the outer fairing wall and the inner fairing wall, one of the outer fairing wall or the inner fairing wall forming a damping wall of the fairing;
at least one piston ring seal disposed at the fairing, the at least one piston ring seal including a first piston ring seal and a second piston ring seal, the first piston ring seal disposed between the outer frame case and the outer fairing wall, and the second piston ring seal disposed between the inner frame case and the inner fairing wall; and
a damping system including at least one damping ring and a plurality of clamp assemblies, each of the at least one damping ring extending circumferentially about the axis, each of the at least one damping ring including a plurality of circumferential ring segments, the at least one damping ring disposed at the outer surface, each of the plurality of clamp assemblies configured to clamp the at least one damping ring against the damping wall.

15. The gas turbine engine of claim 14, wherein the high-pressure turbine includes a bladed turbine rotor, the bladed turbine rotor includes a trailing end rotor blade stage, the trailing end rotor blade stage includes a first quantity of rotor blades of the trailing end rotor blade stage, the damping system includes a second quantity of the plurality of clamp assemblies, and a ratio of the first quantity to the second quantity is non-integral.

16. The gas turbine engine of claim 15, wherein each of the clamp assemblies is disposed circumferentially between a circumferentially-adjacent pair of the plurality of struts.

17. The gas turbine engine of claim 14, wherein the at least one damping ring includes a plurality of radially-stacked damping rings disposed radially between the plurality of clamp assemblies and the damping wall.

18. A mid-turbine frame for a gas turbine engine, the mid-turbine frame comprising:
an outer frame case and an inner frame case extending circumferentially about an axis;
a fairing mounted between the outer frame case and the inner frame case, the fairing including an outer fairing wall, an inner fairing wall, and a plurality of struts, the outer fairing wall and the inner fairing wall extending circumferentially about the axis, each of the outer fairing wall and the inner fairing wall extending between and to an outer surface and an inner surface, the inner surface forming a core flow path through the fairing, the outer surface disposed opposite the inner surface, the plurality of struts extending between and connecting the outer fairing wall and the inner fairing wall, one of the outer fairing wall or the inner fairing wall forming a damping wall of the fairing; and
a damping system including at least one damping ring and a plurality of clamp assemblies, each of the at least one damping ring extending circumferentially about the axis, each of the at least one damping ring including a plurality of circumferential ring segments, the at least one damping ring disposed at the outer radial surface, the plurality of clamp assemblies circumferentially arrayed on the damping wall about the axis with each of the plurality of clamp assembly disposed circumferentially between a circumferentially-adjacent pair of the plurality of struts, each of the plurality of clamp assemblies including a clamp body mounted to the damping wall with the at least one damping ring disposed radially between the clamp body and the damping wall.

19. The mid-turbine frame of claim 18, wherein each of the plurality of clamp assemblies includes a bolt mounting the clamp body to the damping wall.

20. The mid-turbine frame of claim 19, wherein the outer fairing wall forms a bolt aperture for each of the plurality of clamp assemblies, the bolt aperture extends through the damping wall from the outer radial surface to the inner radial surface, and the bolt is disposed in the bolt aperture.
